(19) United States
(12) Patent Application Publication
(10) Pub. No.: US 2009/0285315 A1
(43) Pub. Date: Nov. 19, 2009

(54) APPARATUS AND METHOD FOR ADAPTIVE CHANNEL ESTIMATION AND COHERENT BANDWIDTH ESTIMATION APPARATUS THEREOF

(75) Inventor: Mau-Lin Wu, Hsinchu City (TW)

Correspondence Address: J C PATENTS, 4 VENTURE, SUITE 250, IRVINE, CA, 92618, US

(73) Assignee: FARADAY TECHNOLOGY CORP., Hsinchu (TW)

(21) Appl. No.: 12/121,334

(22) Filed: May 15, 2008

(51) Int. Cl. H04L 27/28

(52) U.S. Cl. 375/260

(57) ABSTRACT

An apparatus and a method for adaptive channel estimation and a coherent bandwidth estimation apparatus are provided. The adaptive channel estimation apparatus includes a first channel estimator, a coherent bandwidth estimator and a second channel estimator. The first channel estimator uses a predetermined approach to calculate a first channel response of each tone of an orthogonal frequency-division multiplexing (OFDM) signal. The coherent bandwidth estimator is coupled to the first channel estimator for calculating a coherent bandwidth according to the first channel responses. The second channel estimator is coupled to the first channel estimator and the coherent bandwidth estimator. For each of the tones, the second channel estimator calculates a weighted average according to the coherent bandwidth and the first channel responses of several adjacent tones including the aforementioned tone. The second channel estimator outputs the weighted average as the second channel response of the aforementioned tone.

### BACKGROUND OF THE INVENTION

1. Field of the Invention

The present invention relates to a channel estimation of an orthogonal frequency-division multiplexing (OFDM) communication system. More particularly, the present invention relates to an adaptive channel estimation of an OFDM communication system.

2. Description of Related Art

In a receiver of an OFDM communication system, before a received signal is interpreted, a channel frequency response thereof has to be first removed. The channel frequency response is generally referred to as channel response. To remove the channel response, the channel response is first estimated, and such estimation is referred to as channel estimation. The channel response may be estimated within a time domain or a frequency domain, and for the OFDM, estimation of the channel response within the frequency domain is more common.

A general known optimal channel estimation method is a minimum mean square error (MMSE) method, though calculation thereof is extremely complicated, and accordingly cost thereof is high. On the other hand, a least square (LS) method is rather simple. In the LS method, the channel response is assumed to be stable around each tone of the OFDM signal. Therefore, only a known standard training sequence is required to be sent, and the receiver then may calculate the channel response of each of the tones according to a ratio between the received training sequence and an original training sequence, and an equation thereof is as follows:

H_{LS}[k]=X*[k]Y[k]/|X[k]²

wherein H_{LS}[k] represents the channel response of a k-th tone, X[k] represents the original training sequence, and Y[k] represents the received training sequence, and signals applied herein are frequency domain signals.

Though the LS method is simple, estimation thereof is still required to be improved without consideration of a relativity of the tones. Therefore, a method of modifying the channel response of one of the tones according to the channel responses of several adjacent tones is provided. Such method may provide a more accurate estimation result while the channel responses are relatively stable. However, when variation of the channel responses is intensive, such method is then non-applicable. Consequently, a method of adjusting the aforementioned channel response modification method according to a state of the channel is further provided, which is referred to as adaptive channel estimation.

FIG. 1 is a diagram illustrating a conventional adaptive channel estimation apparatus 100. The adaptive channel estimation apparatus 100 is disclosed by U.S patent No. 2004/0120428, which may be applied to a wireless local area network (WLAN) system. Wherein, a LS channel estimator 112 utilizes a conventional LS method for channel estimation. A preamble of each network packet of this system has two long symbols to function as the training sequence. A fast Fourier transformer (FFT) 114 performs a fast Fourier transform to a received training sequence 110, and an averager 116 calculates an average value of tones of the long symbols. A divider 118 calculates a LS channel response 122 of each of the tones according to the average value output from the averager 116 and an original long symbol provided by a storage device 120.

A circuit block 124 and a frequency domain smoother 134 are used for performing the adaptive channel estimation, wherein calculation of the circuit block 124 is performed based on the time domain, and a matched filter 126, a filter response correction unit 128 and a channel delay spread estimator 130 are used for calculating a channel impulse response (CIR) time. The frequency domain smoother 134 calculates the average value according to the channel estimation result of the several adjacent tones, so as to modify the channel response 122 for obtaining a more accurate channel response 136. The CIR time provided by the circuit block 124 may influence calculation parameters of the frequency domain smoother 134, which is an essence of the adaptive concept.

Structure of the channel estimation apparatus 100 is simple than that of an apparatus using the MMSE method, though it is still rather complicated. For example, if the CIR time is L, the matched filter 126 of the circuit block 124 then requires L complex multipliers and L complex adders. In case of the most complex channel model of IEEE 802.15.3a UWB channel model, CM4, value of L may reach 50, which leads to a high cost of the circuit.

### SUMMARY OF THE INVENTION

The present invention is directed to an adaptive channel estimation apparatus, which may improve a conventional adaptive channel estimation, so as to provide a more accurate channel response with a simple design.

The present invention is directed to a coherent bandwidth estimation apparatus, which may estimate a coherent bandwidth of a channel, so as to provide a reference to an adaptive channel estimation, and further provide a more accurate channel response.

The present invention is directed to an adaptive channel estimation method, which may be applied to the aforementioned adaptive channel estimation apparatus.

The present invention provides an adaptive channel estimation apparatus including a first channel estimator, a coherent bandwidth estimator and a second channel estimator. The first channel estimator uses a predetermined approach to calculate a first channel response of each tone of an orthogonal frequency-division multiplexing (OFDM) signal. The coherent bandwidth estimator is coupled to the first channel estimator for calculating a coherent bandwidth according to the first channel responses. The second channel estimator is coupled to the first channel estimator and the coherent bandwidth estimator. For each of the tones, the second channel estimator calculates a weighted average according to the coherent bandwidth and the first channel responses of several adjacent tones including the aforementioned tone, and outputs the weighted average as a second channel response of the aforementioned tone.

In an embodiment of the present invention, the coherent bandwidth estimator filtrates each of the tones according to a predetermined condition, and calculates a phase response of each tone which passes the filtration, and further calculates the coherent bandwidth according to the phase responses.

In an embodiment of the present invention, the predetermined condition is that if a power of the first channel response of a certain tone is greater than a threshold value, the tone passes the filtration.

In an embodiment of the present invention, the coherent bandwidth estimator calculates each of the phase responses by utilizing a look-up table.

In an embodiment of the present invention, the coherent bandwidth estimator calculates the coherent bandwidth according to differences among the phase responses.

In an embodiment of the present invention, the second channel estimator determines a plurality of weights according to a comparison of the coherent bandwidth and a plurality of the threshold values, and calculates each of the weighted averages according to the plurality of weights.

In an embodiment of the present invention, the sum of the plurality of weights is a power of 2, and a division performed during calculation of each of the weighted averages is based on a right shift approach.

In an embodiment of the present invention, the adaptive channel estimation apparatus further includes a signal-to-noise ratio (SNR) estimator. The SNR estimator is coupled to the second channel estimator for estimating an SNR. The second channel estimator calculates each of the second channel responses according to the coherent bandwidth and the SNR.

In an embodiment of the present invention, the adaptive channel estimation apparatus is applied to a receiver of an OFDM communication system.

The present invention provides another coherent bandwidth estimation apparatus including a channel estimator and a coherent bandwidth estimator. The channel estimator calculates a channel response of each tone of an OFDM signal according to a predetermined approach. The coherent bandwidth estimator is coupled to the channel estimator for calculating a coherent bandwidth according to a plurality of the channel responses.

The present invention provides an adaptive channel estimation method. The method may be described as follows. First, a first channel response of each tone of an OFDM signal is calculated according to a predetermined approach. Next, a coherent bandwidth is calculated according to a plurality of the first channel responses. Finally, a second channel response of each tone is determined according to the plurality of the channel responses and the coherent bandwidth.

According to the adaptive channel estimation technique provided by the present invention, calculations thereof are totally performed within a frequency domain. In the present invention, the coherent bandwidth is taken as a reference to modify a channel response estimated based on a conventional method such as a least square method by utilizing a weighted average calculation, in which a relativity of the channel responses between adjacent tones are taken into consideration, and circuit design thereof is relatively simple compared to that of the conventional technique. Therefore, the present invention may provide a more accurate channel response than that of the conventional method such as the least square method, and complexity and cost thereof are lower than that of the conventional technique with an equivalent effectiveness.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a block diagram illustrating a conventional adaptive channel estimation apparatus.

FIG. 2 is a block diagram illustrating an adaptive channel estimation apparatus according to an embodiment of the present invention.

FIG. 3 is a block diagram of an adaptive channel estimation apparatus according to another embodiment of the present invention.

### DESCRIPTION OF EMBODIMENTS

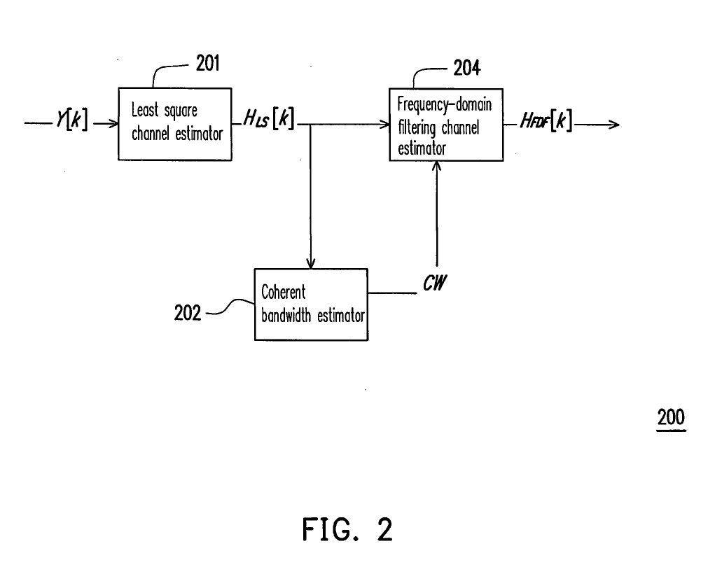

FIG. 2 is a block diagram illustrating an adaptive channel estimation apparatus 200 according to an embodiment of the present invention. The adaptive channel estimation apparatus 200 is applied to a receiver of an OFDM communication system, and includes a least square channel estimator 201, a coherent bandwidth estimator 202 and a frequency-domain filtering channel estimator 204. The coherent bandwidth estimator 202 is coupled to the least square channel estimator 201, and the frequency-domain filtering channel estimator 204 is coupled to the least square channel estimator 201 and the coherent bandwidth estimator 202.

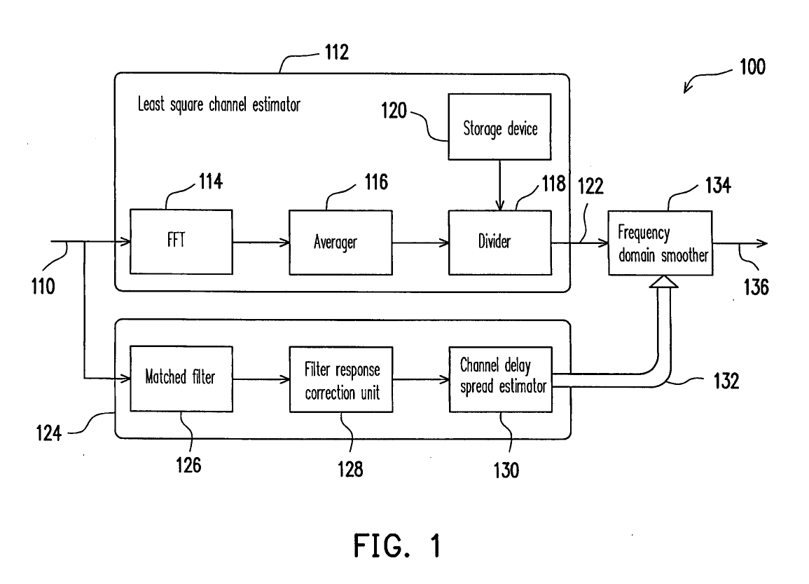

The least square channel estimator 201 calculates a channel response H_{LS}[k] of each tone Y[k] of an OFDM signal according to a conventional least square method, wherein Y[k] is the tone of the k-th sub-carrier at the frequency domain of the OFDM signal received by the receiver. Demanding by the least square method, the OFDM signal must be a known standard signal, for example, a training sequence. Function of the least square channel estimator 201 is similar to that of the least square channel estimator 112 of FIG. 1. The least square channel estimator 201 may calculate an average value of each tone Y[k], and calculates the channel response H_{LS}[k] according to the average value of each tone Y[k] and an original training sequence.

The coherent bandwidth estimator 202 calculates a coherent bandwidth CW according to the channel response H_{LS}[k]. First, the coherent bandwidth estimator 202 filtrates each tone Y[k] of the OFDM signal. Since a part of the tones may have a fading problem due to severe interference of noise, calculation of the coherent bandwidth may be influenced. Therefore, the tones have to be filtrated first. Wherein, a filtration condition thereof is that if a power |H_{LS}(k)|² of the channel response of a certain tone Y[k] is greater than a predetermined threshold value, the tone Y[k] passes the filtration.

Next, the coherent bandwidth estimator 202 calculates a phase response θ[k] of each tone Y[k] which passes the filtration, and an equation thereof is as follows:

$$θ [ k ] = {tan}^{- 1} \{ \frac{Im \{ {H}_{LS} [ k ] \}}{Re \{ {H}_{LS} [ k ] \}} \}$$

Wherein Im{ } and Re{ } respectively represents a real part and an imaginary part of a complex number. To improve an efficiency and reduce a cost thereof, the present embodiment uses a look-up table to calculates the phase response θ[k]. According to an actual application experience, the look-up table with only 4 input bits and 5 output bits is sufficient for application.

Next, the coherent bandwidth estimator 202 calculates a group delay by subtracting the phase responses θ[k] in couples, and calculates an average group delay of the channel, wherein a reciprocal of the average group delay is the coherent bandwidth CW, and an equation thereof is as follows:

$$C W = \frac{N}{{\sum }_{k = 0}^{N - 1} \{ θ [ k ] - θ [ k + 1 ] \}}$$

Wherein N represents the number of the tones Y[k] which pass the filtration.

For each of the tones Y[k], the frequency-domain filtering channel estimator 204 calculates a weighted average value according to the coherent bandwidth CW and the channel responses H_{LS}[k] of several adjacent tones including the tone Y[k], and outputs the weighted average value as a modified channel response H_{FDF}[k] of the tone Y[k], wherein calculation of the weighted average value is as follows:

$${H}_{F D F} [ k ] = \frac{{\sum }_{m = - M}^{M} w g t [ m , C W ] {H}_{LS} [ k + m ]}{{\sum }_{m = - M}^{M} w g t [ m , C W ]}$$

Wherein wgt[m,CW] represents a weight determined based on the coherent bandwidth CW, and number of the weights wgt[m,CW] is 2M+1. The frequency-domain filtering channel estimator 204 determines the weight wgt[m,CW] according to a comparison of the coherent bandwidth CW and a plurality of the predetermined threshold values. For example, the weight of the present embodiment is represented by a following equation:

$$w g t [ m , C W ] = \{ \begin{matrix}[ 0 , 1 , 0 ] & C W < C {W}_{T H 1} \\ [ 1 , 6 , 1 ] & C {W}_{T H 1} \leq C W < C {W}_{T H 2} \\ [ 1 , 2 , 1 ] & C W \geq C {W}_{T H 2}\end{matrix}$$

Wherein CW_{TH1} and CW_{TH2} are predetermined threshold values, and the above equation is equivalent to M=1. The coherent bandwidth CW is an index for indicating an extent of channel variation. The greater the coherent bandwidth CW is, the slight the channel variation is, and now the weight of the adjacent tones may be increased, for example, [1,2,1] of the above equation represents an own weight is 2, and the weight of the adjacent tones is 1. Moreover, a relatively smaller coherent bandwidth CW represents the channel variation is relatively intense, and now the weight of the adjacent tones may be decreased, for example, [1,6,1] of the above equation represents the own weight is 6, and the weight of the adjacent tones is 1. When the channel variation is the most intense, [0,1,0] of the above equation may be applied, and now the H_{FDF}[k] directly equals to the H_{LS}[k] totally without reference of the channel responses of the adjacent tones.

In the present embodiment, the channel response H_{LS}[k] obtained based on the least square method is further modified, so as to obtain the modified channel response H_{FDF}[k]. Since the relativity of the adjacent tones is taken into consideration in the present embodiment, and the adaptive channel estimation is performed with reference of the coherent bandwidth CW, H_{FDF}[k] is then more accurate than H_{LS}[k].

Regardless of a value of the CW, the sum of the weights

$${\sum }_{m = - M}^{M} w g t [ m , C W ]$$

of the present embodiment is always a power of 2. An advantage thereof is that a division operation during calculation of the modified channel response H_{FDF}[k] is unnecessary, and only a bit right shift operation is required, so that complexity and cost of the adaptive channel estimation apparatus 200 may be reduced.

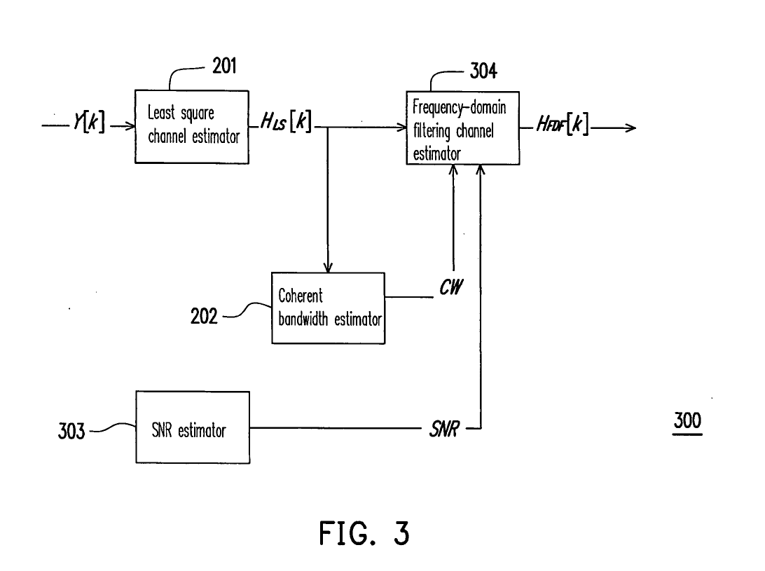

FIG. 3 is a block diagram of an adaptive channel estimation apparatus 300 according to another embodiment of the present invention. The adaptive channel estimation apparatus 300 includes a least square channel estimator 201, a coherent bandwidth estimator 202, an SNR estimator 303 and a frequency-domain filtering channel estimator 304. The coherent bandwidth estimator 202 is coupled to the least square channel estimator 201, the frequency-domain filtering channel estimator 204 is coupled to the least square channel estimator 201, the coherent bandwidth estimator 202 and the SNR estimator 303.

The least square channel estimator 201 and the coherent bandwidth estimator 202 of the adaptive channel estimation apparatus 300 are the same to the corresponding devices of the adaptive channel estimation apparatus 200. The SNR estimator 303 estimates a signal-to-noise ratio SNR. The frequency-domain filtering channel estimator 304 besides receives the coherent bandwidth CW and the channel response H_{LS}[k], which is the same as that of the frequency-domain filtering channel estimator 204 of the adaptive channel estimation apparatus 200 does, and further receives the signal-to-noise ratio SNR. The frequency-domain filtering channel estimator 304 then calculates the modified channel response H_{FDF}[k] according to the H_{LS}[k], CW and SNR.

As to the effectiveness, within environments of a IEEE 802.15.3a UWB channel model CM1 and a frequency hopping mode TFC1, a mean square error (MSE) between the channel response estimated based on the method of the present invention and an actual channel response may be improved for 1.0 dB comparing to a conventional least square method. Similar improvements may also be implemented in other frequency hopping modes. The SNR receivable by the receiver may also be improved for 1.0 dB based on the present embodiment, when a packet error rate thereof reaches 8%.

The channel estimator 201 of the aforementioned embodiment applies the least square method for an initial channel estimation. However, the present invention is not limited thereto. In other embodiments, the channel estimator 201 may also apply other channel estimation methods to achieve the same improvement.

Besides the aforementioned adaptive channel estimation apparatus, the present invention also provides a corresponding adaptive channel estimation method. An operational flowchart of the adaptive channel estimation apparatus 300 of FIG. 3 is an embodiment of the aforementioned adaptive channel estimation method. Technique features of such estimation method have been described in the aforementioned embodiments, and therefore detailed description thereof will not be repeated.

In summary, in the present invention, calculations thereof are totally performed within the frequency domain, and the low cost coherent bandwidth estimator is applied for adjusting a weight parameter of the adaptive channel estimation, in which the relativity of the adjacent tones are taken into consideration. Therefore, the method of the present invention may provide a more accurate channel estimation than that of the conventional method such as the least square method etc. The present invention may be applied to any OFDM communication system, and may provide a more accurate channel response estimation, so that the SNR tolerance of the receiver of the communication system may be improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An adaptive channel estimation apparatus, comprising:
a first channel estimator, using a predetermined approach to calculate a first channel response of each tone of an orthogonal frequency-division multiplexing (OFDM) signal;
a coherent bandwidth estimator, coupled to the first channel estimator for calculating a coherent bandwidth according to the first channel responses; and
a second channel estimator, coupled to the first channel estimator and the coherent bandwidth estimator, for each of the tones, the second channel estimator calculating a weighted average according to the coherent bandwidth and the first channel responses of a plurality of adjacent tones including the tone, and outputting the weighted average as a second channel response of the tone.

2. The adaptive channel estimation apparatus as claimed in claim 1, wherein the first channel estimator calculates an average value of each of the tones, and calculates each of the first channel responses according to each of the average values and an original signal.

3. The adaptive channel estimation apparatus as claimed in claim 1, wherein the predetermined approach is a least square method.

4. The adaptive channel estimation apparatus as claimed in claim 1, wherein the coherent bandwidth estimator filtrates each of the tones according to a predetermined condition, and calculates a phase response of each said tone which passes the filtration, and further calculates the coherent bandwidth according to the phase responses.

5. The adaptive channel estimation apparatus as claimed in claim 4, wherein the predetermined condition is that if a power of the first channel response of the tone is greater than a threshold value, the tone passes the filtration.

6. The adaptive channel estimation apparatus as claimed in claim 4, wherein the coherent bandwidth estimator calculates each of the phase responses by utilizing a look-up table.

7. The adaptive channel estimation apparatus as claimed in claim 4, wherein the coherent bandwidth estimator calculates the coherent bandwidth according to differences among the phase responses.

8. The adaptive channel estimation apparatus as claimed in claim 1, wherein the second channel estimator determines a plurality of weights according to a comparison of the coherent bandwidth and at least one threshold value, and calculates each of the weighted averages according to the plurality of weights.

9. The adaptive channel estimation apparatus as claimed in claim 8, wherein sum of the plurality of weights is a power of 2, and a division performed during a calculation of each of the weighted averages is based on a right shift approach.

10. The adaptive channel estimation apparatus as claimed in claim 1, further comprising:
a signal-to-noise ratio (SNR) estimator, coupled to the second channel estimator for estimating an SNR, wherein the second channel estimator calculates each of the second channel responses according to the coherent bandwidth and the SNR.

11. The adaptive channel estimation apparatus as claimed in claim 1, wherein the adaptive channel estimation apparatus is applied to a receiver of an OFDM communication system.

12. A coherent bandwidth estimation apparatus, comprising:
a channel estimator, for calculating a channel response of each tone of an OFDM signal according to a predetermined approach; and
a coherent bandwidth estimator, coupled to the channel estimator, for calculating a coherent bandwidth according to the channel responses.

13. The coherent bandwidth estimation apparatus as claimed in claim 12, wherein the channel estimator calculates an average value of each of the tones, and calculates each of the channel responses according to each of the average values and an original signal.

14. The coherent bandwidth estimation apparatus as claimed in claim 12, wherein the predetermined approach is a least square method.

15. The coherent bandwidth estimation apparatus as claimed in claim 12, wherein the coherent bandwidth estimator filtrates each of the tones according to a predetermined condition, and calculates a phase response of each said tone which passes the filtration, and further calculates the coherent bandwidth according to the phase responses.

16. The coherent bandwidth estimation apparatus as claimed in claim 15, wherein the predetermined condition is that if a power of the channel response of the tone is greater than a threshold value, the tone passes the filtration.

17. The coherent bandwidth estimation apparatus as claimed in claim 15, wherein the coherent bandwidth estimator calculates each of the phase responses by utilizing a look-up table.

18. The coherent bandwidth estimation apparatus as claimed in claim 15, wherein the coherent bandwidth estimator calculates the coherent bandwidth according to differences among the phase responses.

19. The coherent bandwidth estimation apparatus as claimed in claim 12, wherein the coherent bandwidth estimation apparatus is applied to a receiver of an OFDM communication system.

20. An adaptive channel estimation method, comprising:
(a) calculating a first channel response of each tone of an OFDM signal according to a predetermined approach;
(b) calculating a coherent bandwidth according to the first channel responses; and
(c) determining a second channel response of each of the tones according to the first channel responses and the coherent bandwidth.

21. The adaptive channel estimation method as claimed in claim 20, wherein the step (a) comprises:
calculating an average value of each of the tones, and calculating each of the first channel responses according to each of the average values and an original signal.

22. The adaptive channel estimation method as claimed in claim 20, wherein the predetermined approach is a least square method.

23. The adaptive channel estimation method as claimed in claim 20, wherein the step (b) comprises:
filtrating each of the tones according to a predetermined condition, and calculating a phase response of each said tone which passes the filtration, and further calculating the coherent bandwidth according to the phase responses.

24. The adaptive channel estimation method as claimed in claim 23, wherein the predetermined condition is that if a power of the first channel response of the tone is greater than a threshold value, the tone passes the filtration.

25. The adaptive channel estimation method as claimed in claim 23, wherein the step (b) further comprises:
calculating each of the phase responses by utilizing a look-up table.

26. The adaptive channel estimation method as claimed in claim 23, wherein the step (b) further comprises:
calculating the coherent bandwidth according to differences among the phase responses.

27. The adaptive channel estimation method as claimed in claim 20, wherein the step (c) comprises:
for each of the tones, calculating a weighted average according to the coherent bandwidth and the first channel responses of a plurality of adjacent tones including the tone, and outputting the weighted average as the second channel response of the tone.

28. The adaptive channel estimation method as claimed in claim 27, wherein the step (c) further comprises:
determining a plurality of weights according to a comparison of the coherent bandwidth and at least one threshold value, and calculating each of the weighted averages according to the weights.

29. The adaptive channel estimation method as claimed in claim 28, wherein sum of the weights is a power of 2, and a division performed during a calculation of each of the weighted averages is based on a right shift approach.

30. The adaptive channel estimation method as claimed in claim 20, further comprising:
estimating an SNR; and
calculating each of the second channel responses according to the coherent bandwidth and the SNR.
